(19) United States
(12) Patent Application Publication
(10) Pub. No.: US 2009/0253042 A1
(43) Pub. Date: Oct. 8, 2009

(54) METHOD OF PREPARING POSITIVE ACTIVE MATERIAL FOR RECHARGEABLE LITHIUM BATTERY, POSITIVE ACTIVE MATERIAL FOR RECHARGEABLE LITHIUM BATTERY PREPARED BY SAME, AND RECHARGEABLE LITHIUM BATTERY INCLUDING POSITIVE ACTIVE MATERIAL

(75) Inventors: Yang-Kook Sun, Seoul (KR); Byung-Chun Park, Ansan-si (KR)

Correspondence Address: LEXYOUME IP GROUP, LLC, 5180 PARKSTONE DRIVE, SUITE 175, CHANTILLY, VA, 20151, US

(73) Assignee: EnerCeramic Inc., Namyangju-si (KR)

(21) Appl. No.: 12/421,735

(22) Filed: Apr. 10, 2009

(30) Foreign Application Priority Data
May 7, 2007 (KR) 10-2007-0044125
Apr. 11, 2008 (KR) 10-2008-0033679

(51) Int. Cl. H01M 4/58; H01M 4/88

(52) U.S. Cl. 429/231.95; 252/182.1

(57) ABSTRACT

The present invention relates to a method of preparing a positive active material for a rechargeable lithium battery, a positive active material prepared according to the method, and a rechargeable lithium battery including the same. This manufacturing method includes preparing a complex salt solution by mixing a solution including a metal source material and a chelating agent, disposing the complex salt on the surface of a lithium-included compound by adding a lithium-included compound to the complex salt solution, adding a solution including a fluorine source material to the solution including a lithium-included compound with the complex salt on the surface, and heat-treating the mixture. The present invention provides a simple method of economically preparing a positive active material in which structural transition on the surface is prevented and securing a uniform coating layer. In addition, the positive active material can have improved charge and discharge characteristics, cycle life characteristic, and rate characteristic. It also has improved ion conductivity, and accordingly can improve mobility of lithium ions in an electrolyte and thereby improve discharge potential of a battery. Furthermore, the positive active material can decrease the amount of a conductive material and increase density of a substrate.

### CROSS-REFERENCE TO RELATED APPLICATION

This application claims priority to and the benefit of Korean Patent Application No. 10-2008-0033679 filed in the Korean Intellectual Property Office on Apr. 11, 2008, the entire contents of which are incorporated herein by reference.

### BACKGROUND OF THE INVENTION

(a) Field of the Invention

The present invention relates to a method of preparing a positive active material for a rechargeable lithium battery. More particularly, it relates to method of preparing a positive active material having excellent cycle life, high rate, and resistance characteristics due to a uniform and firm layer.

(b) Description of the Related Art

There has been remarkably increasing demand for a rechargeable battery that can be repeatedly charged and discharged as a power source for portable electronic devices such as PDAs, mobile phones, laptop computers, and the like, as well as for electric bikes, electric vehicles, and the like. In particular, performance of these electronic devices necessarily depends on a rechargeable battery as a power source. Accordingly, there is huge requirement for a rechargeable battery with high performance.

In general, a battery should be stable at a high temperature and have good charge and discharge, cycle life, and high rate characteristics. A rechargeable lithium battery has gained most attention due to its high voltage and high energy density.

A rechargeable lithium battery is classified into a lithium battery using a lithium metal for a negative electrode, and a lithium ion battery using a layered compound such as carbon and the like that is capable of intercalating and deintercalating lithium as a negative electrode. In addition, a rechargeable lithium battery is classified into a liquid battery using a liquid electrolyte, a gel-type polymer battery using a mixed electrolyte of liquid and a polymer, and a solid polymer battery using a polymer alone, depending on the electrolyte.

A commercially available small rechargeable lithium battery includes LiCoO₂ as a positive electrode and carbon as a negative electrode. Further, Japanese Moli Energy Corp. has manufactured a battery including LiMn₂O₄ as a positive electrode, but the LiMn₂O₄ is used very little compared with LiCoO₂.

Positive electrode materials such as LiNiO₂, LiCoₓNi₁₋ₓO₂ (x ranges from 0.2 to 0.5), LiMn₂O₄, and the like are being actively researched. However, the LiNiO₂ has a problem in thermal stability as well as synthesis, and thereby is not yet commercially available. The LiMn₂O₄ is commercially manufactured as a low cost product but has a relatively smaller theoretical capacity of 148 mAh/g than other materials due to its spinel structure. Since it also has a three-dimensional tunnel structure, it has large diffusion resistance during intercalation/deintercalation of lithium ions. In addition, it has a lower diffusion coefficient than LiCoO₂ and LiNiO₂ that have a two-dimensional structure. Further, it has poor cycle life characteristics due to the Jahn-Teller effect. In particular, it has poorer high temperature characteristics than LiCoO₂ at 55° C. or higher, and so is not widely used for a battery.

In addition, a rechargeable lithium battery including this positive active material has sharply deteriorated cycle life during repeated charges and discharges. This is because an electrolyte is decomposed or an active material is deteriorated by moisture inside a battery and other influences, resultantly increasing internal resistance in the battery. Accordingly, many efforts are being made to solve these problems.

Korean Patent Publication No. 10-277796 discloses a method of coating a metal such as Mg, Al, Co, K, Na, Ca, and the like on the surface of a positive electrode material and heat-treating it under an oxidation atmosphere.

Another technology is researched to improve energy density and high rate characteristics by adding TiO₂ to LiCoO₂ active materials (Electrochemical and Solid-State Letters, 4 6, A65-A67 2001). In addition, a new technology is developed to improve cycle life by surface-treating graphite with aluminum (Electrochemical and Solid-State Letters, 4(8), A109-A112, 2001). However, they still have cycle life degradation and gas generation problems due to decomposition of an electrolyte and the like during the charge and discharge.

In addition, an active material is known to be dissolved by acid produced due to oxidation of an electrolyte during the charge, which resultantly deteriorates capacity of a battery (Journal of Electrochemical Society, 143, p 2204, 1996).

Recently, Korean Patent Laid-open No. 2003-32363 discloses a method of coating a hydroxide, an oxyhydroxide, an oxycarbonate, or a hydroxycarbonate salt including a metal such as Mg, Al, Co, K, Na, Ca, Si, Ti, Sn, V, Ge, Ga, B, As, and Zr. However, this technology still has a problem of cycle life decrease of a positive active material, particularly LiCoO₂, at a high voltage.

Recently, a new art of improving high rate characteristics without decreasing capacity at 4.5 V Li/Li⁺ by coating AlF₃ on the surface of a LiCoO₂ active material has been reported (Electrochem. Commun., 8(5), 821-826, 2006). In addition, an oxyfluoride compound with a semiconductor characteristic has higher electron conductivity than a fluoride compound as an insulator (Journal of The Electrochemical Society, 153, 1A159-A170 2006).

The modification of a positive active material is performed by using an aqueous or organic-based material as a solvent. When the solvent is used for surface modification, it may remarkably improve characteristics. However, when it is used in mass production, it may increase cost for process design and it is difficult to form uniform particles therewith.

### SUMMARY OF THE INVENTION

One aspect of the present invention provides a method of preparing a positive active material for a rechargeable lithium battery by forming a uniform and firm coating layer on the surface of a positive active material to deteriorate resistance against acid produced around the positive active material, so that it can increase mobility of lithium ions inside an electrolyte as well as suppress structural change on the surface of the positive active material and reaction with the electrolyte. Another aspect of the present invention provides a method of preparing a positive active material for a rechargeable lithium battery having improved charge and discharge characteristics, cycle life characteristics, high voltage characteristics, high rate characteristics, resistance characteristics, and discharge potential.

Yet another aspect of the present invention provides a positive active material for a rechargeable lithium battery prepared according to the method.

Still another aspect the present invention provides a rechargeable lithium battery including the positive active material.

One exemplary aspect of the present invention provides a method of preparing the positive active material with a coating compound layer on the surface for a rechargeable lithium battery, including:

preparing a complex salt solution by mixing a solution metal including a source material and a chelating agent;

disposing the complex salt on the surface of a lithium-included compound by adding a lithium-included compound to the complex salt solution;

adding a solution of a fluorine source material to the solution including a lithium-included compound with the complex salt on the surface; and

heat-treating the mixture.

Another aspect of the present invention provides a positive active material for a rechargeable lithium battery prepared according to the method.

Yet another aspect of the present invention provides a rechargeable lithium battery including the positive active material.

According to the embodiments of the present invention, a positive active material has no structural transition on the surface and has uniform particles in the coating layer, and can also be economically prepared in a simple process. In addition, the positive active material can have improved charge and discharge characteristics, cycle life characteristics, and rate characteristics. It can have improved mobility of lithium ions in the electrolyte solution, and thereby improved discharge potential. Furthermore, it has improved electrical conductivity and thus may include less conductive material and enhance density of a substrate.

### BRIEF DESCRIPTION OF THE DRAWINGS

FIG. 1 shows a flow chart of preparing a positive active material of the present invention.

FIG. 2 shows a transmission electron microscope (TEM) photograph of Li[Ni_{1/3}CO_{1/3}Mn_{1/3}]O₂ coated with AlF₃ on the surface according to Example 2 of the present invention.

### DETAILED DESCRIPTION OF THE INVENTION

Hereinafter, the present invention is illustrated in more detail.

The present invention provides a method of uniformly disposing a coating compound in a nano-size on the surface of a positive active material by disposing metal ions on the surface of a positive active material by using a chelating agent and then adding a fluorine source material thereto to synthesize a coating compound thereon.

When a positive active material is prepared in this method, it has excellent electrochemical characteristics such as cycle life, discharge potential, electric power, high rate, and the like, and has excellent thermal stability.

The method of preparing a positive active material of the present invention includes: preparing a complex salt solution by mixing a solution including a metal source material with a chelating agent;

coating the complex salt on the surface of a lithium-included compound surface by adding a lithium-included compound to the complex salt solution;

adding a solution including a fluorine source material to the solution including a lithium-included compound with the complex salt on the surface; and

heat-treating the mixture.

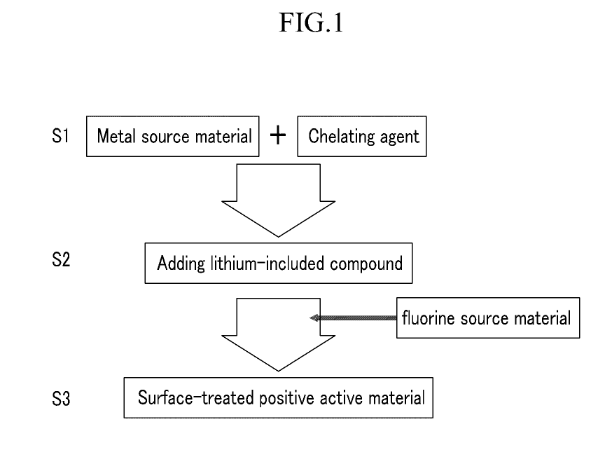

Hereinafter, the method of preparing a positive active material is illustrated step by step in detail referring to FIG. 1.

First of all, a complex salt solution is prepared by mixing a solution including a metal source material with a chelating agent (S1). In other words, a complex salt of chelating agent/cation-metal ion is prepared according to the above mixing reaction.

Herein, pH is critically important in this adding process. The pH plays a role of regulating the reaction speed in the solution. According to one embodiment of the present invention, the pH is in a range of neutral to base. In another embodiment, it is in a range of 5 to 13, or in a range of 7 to 12. When it is in a range of 5 or less, it is less than the pH of distilled water and close to an acidic atmosphere. Accordingly, it is difficult to form a complex salt of chelating agent/cation-metal ion under this atmosphere. When it is higher than 13, it may dissociate the complex salt of the chelating agent/cation-metal ion under a strong base atmosphere.

The metal source material is at least a metal selected from the group consisting of a Group 1 element, a Group 2 element, a Group 3 transition element, a Group 4 transition element, a Group 5 transition element, a Group 6 transition element, a Group 7 transition element, a Group 8 transition element, a Group 9 transition element, a Group 10 transition element, a Group 11 transition element, a Group 12 transition element, a Group 13 element, a Group 14 element, a Group 15 element, a Group 16 element, a Group 18 element, a lanthanide element, and a combination thereof. Specifically, the Group 1 element may include Li, Na, and K, the Group 2 element may include Mg, Ca, and Sr, the Group 3 transition element may include Sc and Y, the Group 4 transition element may include Ti and Zr, the Group 5 transition element may include V, Nb, and Ta, the Group 6 transition element may include Cr, Mo, and W, the Group 7 transition element may include Mn, the Group 8 transition element may include Fe, the Group 9 transition element may include Co, the Group 10 transition element may include Ni, the Group 11 transition element may include Cu, the Group 12 transition element may include Zn, the Group 13 element may include B, Al, Ga, and In, the Group 14 element may include C, Si, Ge, Sn, and Hf, the Group 15 element may include P, As, Bi, and Sb, the Group 16 element may include S, the Group 18 element may include Xe, and the lanthanide element may include La, Ce, Sm, Nd, and Gd. Preferably, it may include more than one metal selected from the group consisting of Sc, Y, Zr, V, Nb, Cr, Mo, W, Mn, Fe, Co, B, Al, Ga, In, Sn, As, La, Ce, Sm, Gd, and a combination thereof.

Examples of the metal source material may be selected from the group consisting of nitrides, sulfides, chlorides, oxides, and a combination thereof including the metal, but is not limited thereto and may include any material that is capable of dissociating metal ions.

Representative examples of the metal source material may be selected from the group consisting of Al(NO₃)₃.9H₂O, Al₂(SO₄)₃, AlCl₃, NaAlO₂, Zr(NO₃)₂.5H₂O, and a combination thereof.

The metal source materials have a coordinate covalent bond with a chelating agent and can be easily disposed on the surface of a lithium-included compound, even in a nano-size.

In addition, when the solution including a metal source material is mixed with a chelating agent, an ammonium-included compound may be added thereto. The ammonium-included compound may be selected from the group consisting of NH₄OH, ammonium hydrogen fluoride, and a combination thereof.

The solution including a metal source material may include any solvent that can dissolve the metal source material and the chelating agent, and has miscibility with a fluorine source material solution added later. The solvent may be selected from the group consisting of water, alcohol, ether, and a combination thereof. The alcohol may include a C1 to C4 lower alcohol, in particular, one selected from the group consisting of methanol, ethanol, isopropanol, and a combination thereof. The ether may include ethylene glycol or butylene glycol.

The chelating agent may include one or more from the group consisting of an ammonium cation-included compound, an organic acid, a polyelectrolyte, and the like.

The ammonium cation-included compound may include NH₄OH, NH₄₂SO₄, NH₄NO₃, or a combination thereof. The organic acid may include citric acid, glycolic acid, or a combination thereof. In addition, the polyelectrolyte may include polysodium styrene sulfonate, polypeptide, polyacrylic acid, or combinations thereof. In particular, it may include NH₄OH, (NH₄)₂SO₄, NH₄NO₃, or a combination thereof, which can easily dissociate ammonium ions in the solution.

The chelating agent is dissociated in the metal source material solution and is combined with metal ions and forms a complex salt. Resultantly, a complex salt solution in which a complex salt chelating agent of cation-metal ion exists in the solvent is prepared.

The metal source material and chelating agent are mixed in a ratio of 1:1 to 1:10 moles. When the chelating agent is used in an amount of 1 mole or less based on 1 mole of the metal source material, it may have little effect. When it is included within an amount of 10 moles, it is impossible to obtain a desired pH.

When an ammonium cation-included compound such as NH₄OH, (NH₄)₂SO₄, and NH₄NO₃ as the chelating agent or an ammonium-included compound is further added during the process of mixing a chelating agent with the metal source material solution, an ammonium metal fluoride can be formed on the surface.

In addition, a metal source material may be used in proportion to the amount of a lithium-included compound, which is added later. In other words, a metal may be included in an amount of 0.001 to 20 mol % in a metal source material based on the amount of a lithium-included compound added subsequently. In another embodiment, it may be included in an amount of 0.005 to 15 mol % or in an amount of 0.01 to 10 mol % based on the amount of a lithium-included compound added subsequently. When the metal source material is included at less than the range, it may have little coating effect. On the contrary, when it is included out of the range, it may deteriorate electrochemical characteristic such as discharge charge, high rate characteristic, and the like.

Next, the complex salt is disposed on the surface of a lithium-included compound by adding a lithium-included compound to the complex salt solution (S2 in FIG. 1).

The lithium-included compound may intercalate and deintercalate lithium ions and is commonly used for a rechargeable lithium battery, but has no particular limit in the present invention. In particular, it may include a layered lithium composite metal oxide including a hexagonal, monoclinic, or orthorhombic crystalline structure, or a spinel or olivine lithium composite metal oxide having a cubic crystalline structure. It may be represented by the following Formulae 1 to 7.

LiₐNiₓCo_{y}Mn_{z}M_{1-x-y-z}O₂Q_{σ} [Chemical Formula 1]

In the above Formula 1, M is an element selected from the group consisting of B, Mg, Al, Cr, V, Ti, Fe, Zr, Zn, Si, Y, Nb, Ga, Sn, Mo, W, and a combination thereof, Q is a halogen or sulfur, 1.0≦a≦1.2, 0.0≦x≦0.95, 0.0≦y≦0.7, 0.0≦z≦0.7, 0.0≦1-x-y-z≦0.3, and 0.0≦σ≦0.1.

LiₐCo_{1-x-y}ZrₓM_{y}O₂Q_{σ} [Chemical Formula 2]

In the above Formula 2, M is an element selected from the group consisting of Mg, B, Al, Cr, V, Ti, Fe, Zr, Zn, Si, Y, Nb, Ga, Sn, Mo, W, and a combination thereof, Q is halogen or sulfur, 1.0≦a≦1.2, 0.0≦x≦0.05, 0.0≦y≦0.1, 0.0≦x+y≦0.1, and 0.0≦σ≦0.1.

LiₐMn₁₋ₓMₓO₂Q_{σ} [Chemical Formula 3]

In the above Formula 3, M is an element selected from the group consisting of B, Mg, Al, Cr, V, Ti, Fe, Zr, Zn, Si, Y, Nb, Ga, Sn, Mo, W, and a combination thereof, Q is a halogen or sulfur, 1.0≦a≦1.2, 0.0≦x≦0.5, and 0.0≦σ≦0.1.

LiₐMn₂₋ₓMₓO₄Q_{σ} [Chemical Formula 4]

In the above Formula 4, M is an element selected from the group consisting of B, Li, Mg, Al, Ca, Sr, Cr, V, Ti, Fe, Co, Ni, Zr, Zn, Si, Y, Nb, Ga, Sn, Mo, W, and a combination thereof, Q is a halogen or sulfur, 1.0≦a≦1.3, 0.0≦x≦0.2, and 0.0≦σ≦0.1.

LiₐMn₂₋ₓMₓO₄Q_{σ} [Chemical Formula 5]

In the above Formula 5, M is an element selected from the group consisting of B, Li, Mg, Al, Ca, Sr, Cr, V, Ti, Fe, Co, Ni, Zr, Zn, Si, Y, Nb, Ga, Sn, Mo, W, and a combination thereof, Q is a halogen or sulfur, 1.0≦a≦1.3, 0.3≦x≦0.7, and 0.0≦σ≦0.1.

Li₄₊ₐTi₄₋ₓMₓO₁₂Q_{σ} [Chemical Formula 6]

In the above Formula 6, M is an element selected from the group consisting of Li, Mg, Al, Ca, Sr, Cr, V, Ti, Fe, Co, Ni, Zr, Zn, Si, Y, Nb, Ga, Sn, Mo, W, and a combination thereof, Q is a halogen or sulfur, 0.0≦a≦0.1, 0.0≦x≦0.1, and 0.0≦σ≦0.1.

LiMₓPO₄Q_{σ} [Chemical Formula 7]

In the above Formula 7, M is an element selected from the group consisting of Co, Ni, Mn, Fe, Mg, V, Ti, Fe, Zr, Zn, Si, Y, Nb, Ga, Sn, Mo, W, and a combination thereof, Q is a halogen or sulfur, 0.0≦a≦0.1, 0.0≦x≦0.1, and 0.0≦σ≦0.02.

The lithium composite metal oxides of the above Formulas 1 to 2 have a hexagonal crystalline structure. The lithium composite metal oxide of the above Formula 3 has a monoclinic or orthorhombic crystalline structure, the lithium composite metal oxides of the above Formulae 4 to 7 have a cubic crystalline structure, and the lithium composite metal oxide of the above Formula 8 has an olivine structure.

Then, a fluorine source material solution is added to a lithium-included compound solution with the complex salt on the surface (S3 in FIG. 1).

The fluorine source material may be selected from the group consisting of HF, NH₄F, or a combination thereof, which is easily dissociated in a solution. The solvent in the solution is selected from the group consisting of water, alcohol, and ether, or a mixed solvent thereof. The alcohol may include a C1 to C4 lower alcohol. For example, it may be selected from the group consisting of methanol, ethanol, isopropanol, and a combination thereof. The ether may include ethylene glycol or butylene glycol.

The fluorine source material is used in an amount of 1 to 10 moles based on 1 mole of the metal source material. When the metal source material and fluorine source material are mixed out of the ratio, it may be hard to obtain a desired coating compound.

When a fluorine source material is added to a lithium-included compound solution with the complex salt on the surface, the fluorine source material reacts with the complex salt and forms a chelating agent/cation-metal-fluorine compound. The formed compound is a precursor for a coating compound such as metal fluoride. This precursor in a nano-size for a coating compound is formed on the surface of a lithium-included compound.

Then, the resulting mixture is heat-treated.

Before the heat treatment, it may be additionally dried.

The drying is performed at 110 to 200° C. for 15 to 30 hours by using a common device.

The heat treatment may be performed at a temperature of 300 to 1000° C. In addition, it is performed for 2 to 10 hours under an inert atmosphere. The inert atmosphere is provided by implanting nitrogen, argon, or a mixed gas thereof. When the heat treatment is performed at 300° C. or lower, impurities therein may not be appropriately removed, deteriorating purity. When it is performed at a temperature of 1000° C. or higher, it is higher than a melting point of a coating compound, thereby growing particles.

According to the heat treatment, cations in the chelating agent are removed, and a coating compound, which is a metal-fluorine compound, remains on the surface of the lithium-included compound. In other words, a coating compound layer is formed on the surface of a lithium-included compound.

The coating compound may be included in an amount of 0.01 to 15 parts by weight based on 100 parts by weight of the lithium-included compound. In another embodiment, it may be included in an amount of 0.03 to 10 parts by weight or in an amount of 0.05 to 8 parts by weight. When it is included at less than the range, it may have little coating effect. On the contrary, when it is included out of the range, it may deteriorate electrochemical characteristic such as discharge capacity, high rate characteristic, and the like.

The coating compound may be selected from the group consisting of a metal fluoride, a metal oxyfluoride, a metal oxide, an ammonium metal fluoride, and a combination thereof.

When the metal fluoride and the metal oxyfluoride are coated on the surface of a lithium-included compound, they protect the lithium-included compound from acid, particularly from hydrofluoric acid in an electrolyte during the surface coating and suppress internal resistance increase by increasing moving speed of lithium ions to a lithium-included compound in an electrolyte as well as maintains the crystalline structure of the lithium-included compound (J. of Electrochem. Soc, 154 (3), A168-A172 (2007)). In addition, the metal oxide protects a lithium-included compound from acid like the metal fluoride or metal oxyfluoride, and suppresses internal resistance increase by increasing moving speed of lithium ions into a lithium compound in an electrolyte, and maintains the crystalline structure of the lithium-included compound.

When the coating compound is coated on the surface of a positive active material, it increases moving speed of lithium ions from the electrolyte to the positive active material and suppresses internal resistance increase, and it protects the positive active material from hydrofluoric acid in the electrolyte and maintains its crystalline structure (J. of Electrochem. Soc, 154(3), A168-A172 (2007)).

Examples of the metal fluoride include one selected from the group consisting of LiF, NaF, KF, MgF₂, CaF₂, CuF₂, CdF₂, FeF₂, MnF₂, MgF₂, NiF₂, PbF₂, SnF₂, SrF₂, XeF₂, ZnF₂, AlF₃, BF₃, BiF₃, CeF₃, CrF₃, FeF₃, InF₃, LaF₃, MnF₃, NdF₃, VOF₃, YF₃, CeF₄, GeF₄, HfF₄, SiF₄, SnF₄, TiF₄, VF₄, ZrF₄, VF₅, NbF₅, SbF₅, TaF₅, BiF₅, MoF₆, ReF₆, SF₆, WF₆, and a combination thereof.

The metal oxyfluoride includes at least one metal selected from the group consisting of a Group 3 transition element, a Group 4 transition element, a Group 5 transition element, a Group 6 transition element, a Group 7 transition element, a Group 8 transition element, a Group 9 transition element, a Group 13 element, a Group 14 element, a Group 15 element, a lanthanide element, and a combination thereof. In particular, the Group 3 transition element may include Sc and Y, the Group 4 transition element may include Ti and Zr, the Group 5 transition element may include V and Nb, the Group 6 transition element may include Cr, Mo, and W, the Group 7 transition element may include Mn, the Group 8 transition element may include Fe, the Group 9 transition element may include Co, the Group 13 element may include B, Al, Ga, and In, the Group 14 element may include C, Si, Ge, and Sn, the Group 15 element may include P, As, and Sb, and the lanthanide element may include La, Ce, Sm, and Gd. Specifically, the metal oxyfluoride may include at least one metal selected from the group consisting of Sc, Y, Zr, V, Nb, Cr, Mo, W, Mn, Fe, Co, B, Al, Ga, In, Sn, As, La, Ce, Sm, Gd, and a combination thereof.

The metal oxide may include at least one metal selected from the group consisting of Mg, Ca, Sr, B, Al, Y, Zr, Mo, W, Cr, Fe, Co, Ni, Zn, Ga, Ge, In, Sn, Bi, P, and a combination thereof.

The ammonium metal fluoride may include (NH₄)ₓMF_{y} (M is selected from the group consisting of a Group 3 transition element, a Group 4 transition element, a Group 5 transition element, a Group 6 transition element, a Group 7 transition element, a Group 8 transition element, a Group 9 transition element, a Group 13 element, a Group 14 element, a Group 15 element, a lanthanide element, and a combination thereof, x is in a range of 1 to 10, and y is in a range of 2 to 16).

The positive active material is prepared by coating a lithium-included compound with a surface treatment compound selected from the group consisting of a metal fluoride, a metal oxyfluoride, a metal oxide, and a combination thereof that are capable of intercalating/deintercalating lithium ions on the surface. In particular, the coating compound is included in an amount of 0.001 to 20 molar equivalent mass on the surface of a lithium-included compound based on 100 moles of the lithium-included compound that can intercalate/deintercalate lithium ions. In another embodiment, it may be included in an amount of 0.005 to 15 molar equivalent mass or in an amount of 0.01 to 10 molar equivalent mass.

This positive active material has increased resistance against acid and is suppressed from reaction with an electrolyte, and thereby can not only improve capacity decrease but can also improve mobility of lithium ions and thereby discharge potential, resultantly improving the charge and discharge characteristics, cycle life characteristic, and rate characteristic.

In addition, when the positive active material is stored for a long period, it may be heat-treated one more time. The heat treatment may be performed at 300 to 1000° C. for 2 to 10 hours under an inert atmosphere. This additional heat treatment may be performed when the positive active material is stored for 24 hours or more. However, there is no limit to maximum storage time, as the heat treatment is performed when it is stored for 24 hours or more. The positive active material is excessively exposed to moisture and air during the long time storage and has a negative reaction on the surface, deteriorating its characteristics. However, when it is heat-treated again, it can recover the characteristics.

According to the embodiment of the present invention, a positive active material can be used for a rechargeable lithium battery.

The present invention provides a rechargeable lithium battery including a positive electrode including the positive active material, a negative electrode including a negative active material that can intercalate/deintercalate lithium ions, and an electrolyte.

The rechargeable lithium battery has an excellent output characteristic at a higher rate. In addition, it has excellent thermal stability as well as capacity and cycle life characteristics.

In general, a rechargeable lithium battery may be classified as a lithium ion battery, a lithium ion polymer battery, and a lithium polymer battery depending on kinds of a separator and an electrolyte, and may be shaped as a cylinder, a prism, a coin, a pouch, and the like.

A rechargeable lithium battery according to an exemplary embodiment of the present invention is representatively fabricated by disposing a separator between negative and positive electrodes to prepare an electrode assembly, and injecting an electrolyte therein to impregnate the negative and positive electrodes and the separator.

The positive electrode may be the above-described positive electrode according to the present invention.

The positive electrode may be fabricated by preparing a composition for a positive active material by mixing the positive active material of the present invention, a conductive material, and a binder, coating the composition on a positive electrode current collector such as aluminum foil, and compressing it.

The binder may include polyvinyl alcohol, carboxylmethyl cellulose, hydroxypropyl cellulose, diacetyl cellulose, polyvinyl chloride, polyvinyl pyrrolidone, polytetrafluoroethylene, polyvinylidene fluoride, polyethylene, polypropylene, or the like, but is not limited thereto.

In addition, the conductive material may include any conductive material as long as it is used for a rechargeable battery, for example a metal powder such as natural graphite, artificial graphite, carbon black, acetylene black, ketjen black, carbon fiber, copper, nickel, aluminum, silver, and the like, or a metal fiber and the like.

The negative electrode includes a negative active material. The negative active material may include a compound that can reversibly intercalate/deintercalate lithium. Specific examples of the negative active material are a carbonaceous material such as artificial graphite, natural graphite, graphitized carbon fiber, amorphous carbon, and the like, lithium, an alloy such as a lithium-included alloy, and a compound that can intercalate/deintercalate lithium ions such as an intermetallic compound, an organic compound, an inorganic compound, a metal complex, an organic polymer compound, and the like. These compounds may be used singularly or as a mixture thereof, as long as they do not damage effects of the present invention.

Examples of the carbonaceous material may be selected from the group consisting of coke, thermal decomposition carbon, natural graphite, artificial graphite, meso-carbon microbeads, graphitized mesophase spherules, vapor phase growth carbon, glass carbon, carbon fiber including polyacrylonitriles, pitches, celluloses, vapor phase growth carbon-based fiber, amorphous carbon, and carbon-fired organic material. They may be used singularly or as a mixture as long as they do not damage effects of the present invention.

The lithium alloy may include a Li—Al-based alloy, a Li—Al—Mn-based alloy, a Li—Al—Mg-based alloy, a Li—Al—Sn-based alloy, a Li—Al—In-based alloy, a Li—Al—Cd-based alloy, a Li—Al—Te-based alloy, a Li—Ga-based alloy, a Li—Cd-based alloy, a Li—In-based alloy, a Li—Pb-based alloy, a Li—Bi-based alloy, a Li—Mg-based alloy, and the like. The alloy and intermetallic compound may include a compound including a transition metal and silicon, a compound including a transition metal and tin, or the like. In another embodiment, it may particularly include a nickel-silicon compound.

Like the positive electrode, the negative electrode may be fabricated by preparing a composition for a negative active material by mixing the negative active material, a binder, and selectively a conductive material, and coating the composition on a negative electrode current collector such as copper foil.

The electrolyte may include a non-aqueous electrolyte, a well-known solid electrolyte, or the like, which dissolve a lithium salt.

The lithium salt may without limitation include a common lithium salt but has no particular limit, for example, LiClO₄, LiBF₄, LiPF₆, LiAlCl₄, LiSbF₆, LiSCN, LiCF₃SO₃, LiCF₃CO₂, Li(CF₃SO₂)₂, LiAsF₆, LiN(CF₃SO₂)₂, LiB₁₀Cl10, LiBOB (lithium bis(oxalato)borate), a lower aliphatic lithium carbonate, chloroborane lithium, lithium tetraphenylborate, and imides such as LiN(CF₃SO₂)(C₂F₅SO₂), LiN(CF₃SO₂)₂, LiN(C₂F₅SO₂)₂, LiN(CF₃SO₂)(C₄F₉SO₂), and the like.

The lithium salts may be used singularly or as a mixture thereof, as long as they do not damage effects of the present invention. In particular, LiPF₆ is used.

In addition, carbon tetrachloride, ethylene trifluorochloride, phosphate, or the like may be added to an electrolyte in order to make the electrolyte inflammable.

Further, the electrolyte may include a solid electrolyte selected from the group consisting of an inorganic solid electrolyte, an organic solid electrolyte, and a mixture thereof, rather than the aforementioned electrolyte.

The inorganic solid electrolyte may be selected from the group consisting of Li₄SiO₄, Li₄SiO₄—LiI—LiOH, Li₃PO₄—Li₄SiO₄, Li₂SiS₃, Li₃PO₄—Li₂S—SiS₂, a phosphorus sulfide compound, and mixtures thereof.

The organic solid electrolyte may include polyethylene oxide, polypropylene oxide, polyvinyl alcohol, polyvinylidene fluoride, fluorinepropylene, and the like, a derivative thereof, a mixture thereof, a copolymer thereof, or the like.

The non-aqueous organic solvent plays a role of a medium for transferring ions related to electrochemical reaction of a battery. Examples of the non-aqueous organic solvent may include carbonate-based, ester-based, ether-based, or ketone-based solvents.

The carbonate-based solvent may be at least one selected from the group consisting of cyclic carbonate, cyclic carbonic acid ester, and a mixture thereof. The cyclic carbonate may be selected from the group consisting of ethylene carbonate (EC), propylene carbonate (PC), butylene carbonate (BC), vinylene carbonate (VC), and a mixture thereof. In addition, the cyclic carbonic acid ester may be selected from the group consisting of non-cyclic carbonates such as dimethyl carbonate (DMC), diethyl carbonate (DEC), ethyl methyl carbonate (EMC), dipropylcarbonate (DPC), and the like, aliphatic carbonic acid esters such as methyl formate, methyl acetate, methyl propionate, ethyl propionate, and the like, γ-butyrolactone (GBL), and mixtures thereof. The aliphatic carbonic acid ester may be included at 20 volume % or less, as needed.

A separator may be positioned between positive and negative electrodes depending on kinds of a rechargeable lithium battery. The separator may include polyethylene, polypropylene, polyvinylidene fluoride, or multilayers thereof, a double layer of polyethylene/polypropylene, a triple layer of polyethylene/polypropylene/polyethylene, a triple layer of polypropylene/polyethylene/polypropylene, and a mixed multilayer thereof.

The following examples illustrate the present invention in more detail. However, it is understood that the present invention is not limited by these examples.

### Example 1

### Preparation of a Solution Containing a Lithium-Included Compound with a Chelating Agent/Cation-Metal Ion Complex Salt on the Surface

50 ml of an Al(NO₃)₃.9H₂O aqueous solution was prepared to include Al in an amount of 0.125 mol % based on a lithium-included compound in a 500 ml glass beaker. The aqueous solution was agitated at a speed of 600 rpm, while being maintained at a temperature of 20° C. Next, a lithium-included compound, Li[Ni_{1/3}CO_{1/3}Mn_{1/3}]O₂, was slowly impregnated in the aqueous solution, and 1.2 ml of NH₄OH was added thereto to regulate its pH to 10.00. Herein, the NH₄OH was used in a mole ratio of 7 with respect to 1 of the Al. Then, the resulting mixture was further agitated to form an ammonia-metal ion complex salt, preparing a ammonia-metal ion complex salt and lithium-included compound solution.

### Preparation of a Positive Active Material Surface-Treated with a Fluorine Salt-Containing Solution

50 ml of an NH₄F aqueous solution was prepared and added to the ammonia-metal ion complex salt and lithium-included compound solution at a speed of 5 ml/min based on 50 ml of Al(NO₃)₃.9H₂O. Herein, NH₄F was used in a ratio of 7 moles to 1 mole of the Al(NO₃)₃.9H₂O. The mixture was agitated at a speed of 1000 rpm at 20° C. Herein, it had pH of 10.00 during the reaction.

The reactant was dried at a 110° C. thermostat for 24 hours, and then heat-treated at 400° C., preparing a positive active material coated with Li[Ni_{1/3}CO_{1/3}Mn_{1/3}]O₂ and AlF₃ on the surface.

Fabrication of Cells

The positive active material, super-P as a conductive material, and polyvinylidene fluoride (PVdF) as a binder were mixed in a weight ratio of 85:7.5:7.5, preparing a slurry. The slurry was uniformly coated on a 20 μm-thick aluminum film and vacuum-dried at 120° C., fabricating a positive electrode.

The positive electrode, a lithium foil as a counter electrode, a porous polyethylene film (Celgard 2300, thickness: 25 μm, Celgard LLC Co.) as a separator, and an electrolyte solution, which is prepared by dissolving LiPF₆ in a concentration of 1 M in a solvent of ethylene carbonate and diethyl carbonate mixed in a volume ratio of 1:1, were used to fabricate a coin cell according to a common manufacturing process.

### Example 2

A positive active material coated with Li[Ni_{1/3}CO_{1/3}Mn_{1/3}]O₂ and AlF₃ on the surface and a cell including the same were fabricated according to the same method as Example 1, except for preparing 50 ml of an Al(NO₃)₃.9H₂O aqueous solution to include Al in an amount of 0.25 mol % against a lithium-included compound in a 500 ml glass beaker.

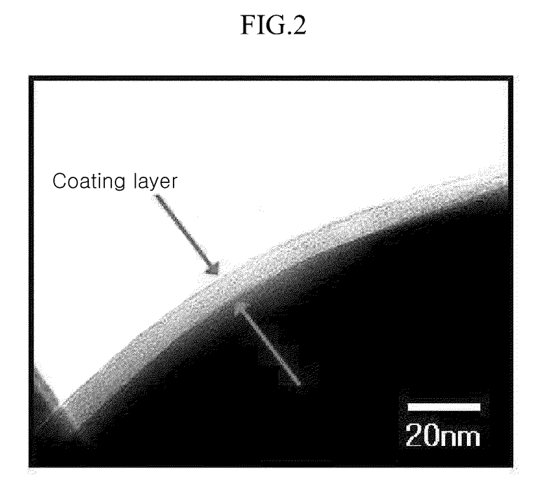

The positive active material was photographed of with a transmission electron microscope (TEM). It is provided in FIG. 2. As shown in FIG. 2, Li[Ni_{1/3}CO_{1/3}Mn_{1/3}]O₂ is coated with AlF₃ on the surface.

### Example 3

A positive active material coated with Li[Ni_{1/3}CO_{1/3}Mn_{1/3}]O₂ and AlF₃ on the surface and a cell including the same were fabricated according to the same method as Example 1, except for preparing 50 ml of an AlN(O₃)₃.9H₂O aqueous solution to include Al in an amount of 0.5 mol % against a lithium-included compound in a 500 ml glass beaker.

### Example 4

A positive active material coated with Li[Ni_{1/3}CO_{1/3}Mn_{1/3}]O₂ and AlF₃ on the surface and a cell including the same were fabricated according to the same method as Example 2, except for using Li[Ni_{0.5}Mn_{0.5}]O₂ as a lithium-included compound.

### Example 5

A positive active material coated with Li[Ni_{1/3}CO_{1/3}Mn_{1/3}]O₂ and AlF₃ on the surface and a cell including the same were fabricated according to the same method as Example 3, except for using Li[Ni_{0.5}Mn_{0.5}]O₂ as a lithium-included compound.

### Example 6

A positive active material coated with Li[Ni_{1/3}CO_{1/3}Mn_{1/3}]O₂ and AlF₃ on the surface and a cell including the same were fabricated according to the same method as Example 2, except for preparing the positive active material by exposing Li[Ni_{1/3}CO_{1/3}Mn_{1/3}]O₂ coated with AlF₃ to air on the surface according to Example 2, storing it for 48 hours, and heat-treating it at 400° C.

### Example 7

A positive active material was fabricated according to the same method as Example 5, except for using Li[Ni_{0.5}Mn_{0.5}]O₂ coated with AlF₃ on the surface.

### Example 8

### Preparation of a Lithium-Included Compound Solution Having Chelating Agent Cation-Metal Ion Complex Salt on the Surface

50 ml of Al(NO₃)₃.9H₂O aqueous solution was prepared to include Al in an amount of 0.125 mol % against a lithium-included compound in a 500 ml glass beaker

The aqueous solution was agitated at a speed of 600 rpm, while being maintained at 20° C. Next, a Li[Ni_{1/3}CO_{1/3}Mn_{1/3}]O₂ lithium-included compound was slowly impregnated in the aqueous solution, and 1.7 ml of NH₄OH was added thereto to adjust its pH to 10.5. The NH₄OH was included in a mole ratio of 10 to 1 with respect to the Al. Then, the resulting mixture was further agitated to promote an ammonia-metal ion complex salt, preparing an ammonia-metal ion complex salt and lithium-included compound solution.

### Preparation of a Positive Active Material Surface-Treated with a Fluorine Salt Solution

50 ml of an NH₄F aqueous solution based on 50 ml of Al(NO₃)₃.9H₂O was added to the ammonia-metal ion complex salt and lithium-included compound solution at a speed of 5 ml/min. The NH₄F was used in a mole ratio of 7 to 1 with respect to Al(NO₃)₃.9H₂O. The reactant was agitated at 20° C. at a speed of 1000 rpm. Herein, it had pH of 10.5 during the reaction.

The reactant was dried at 120° C. for 24 hours, preparing a positive active material including Li[Ni_{1/3}CO_{1/3}Mn_{1/3}]O₂ and (NH₄)₃AlF₆ coated on the surface.

The positive active material was used according to the same method as Example 1 to fabricate a cell.

### Example 9

A positive active material including Li[Ni_{0.5}Mn_{0.5}]O₂ and (NH₄)₃AlF₆ coated on the surface and a cell including the same were fabricated according to the same method as Example 8, except for using Li[Ni_{0.5}Mn_{0.5}]O₂ as a lithium-included compound.

### Comparative Example 1

A cell was fabricated according to the same method as Example 1 except for using Li[Ni_{1/3}CO_{1/3}Mn_{1/3}]O₂ as a positive active material without the AlF₃ coating process.

### Comparative Example 2

A cell was fabricated according to the same method as Example 1, except for using Li[Ni_{0.5}Mn_{0.5}]O₂ as a positive active material without the AlF₃ coating process.

### Comparative Example 3

A cell was fabricated according to the same method as Comparative Example 2, except for preparing a positive active material by using Li[Ni_{1/3}CO_{1/3}Mn_{1/3}]O₂ coated with AlF₃ on the surface according to Example 2 and exposing it to air.

### Comparative Example 4

A cell was fabricated according to the same method as Comparative Example 3, except for preparing a positive active material by using Li[Ni_{0.5}Mn_{0.5}]O₂ coated with AlF₃ on the surface according to Example 3.

### Experimental Example 1

The cells according to Examples 1 to 5 and Comparative Examples 1 and 2 were charged and discharged twice with a 0.2 C-rate (36 mA/g) up to 3.0-4.5 V at 30° C., and then charged and discharged for 40 cycles with a 0.5 C-rate (90 mA/g) to examine charge and discharge, resistance, and cycle life characteristics by using a charge/discharger (Model No.: Toscat 3000U, Toyo Co., Japan), which is an electrochemical analysis device. Table 1 shows the 40th cycle life characteristic percentage against the first cycle discharge capacity (0.2 C-rate and 0.5 C-rate) and first cycle discharge capacity (0.5 C-rate). In addition, Table 2 shows the IR-Drop value depending on resistance of a positive active material during the charge.

TABLE 1

| | | Discharge | Discharge | |
|---|---|---|---|---|
| | | capacity | capacity | |
| | | (mAh/g) | (mAh/g) | Cycle |
| | | (0.2 C) | (0.5 C) | life (%) |
| Li[Ni_{1/3}Co_{1/3}Mn_{1/3}]O₂ | Ex. 1 | 184.06 | 177.59 | 92.2 |
| | Ex. 2 | 184.16 | 178.48 | 94.5 |
| | Ex. 3 | 186.12 | 177.05 | 92.3 |
| | Comp. Ex. 1 | 181.19 | 175.12 | 88.9 |
| Li[Ni_{0.5}Mn_{0.5}]O₂ | Ex. 4 | 175.92 | 167.04 | 92.1 |
| | Ex. 5 | 175.94 | 165.05 | 94.7 |
| | Comp. Ex. 2 | 170.58 | 160.65 | 91.7 |

The cycle life characteristic was calculated as discharge capacity at 40^{th} cycle/discharge capacity at first cycle*100.

Referring to Table 1, the cells including Li[Ni_{1/3}CO_{1/3}Mn_{1/3}]O₂ coated with AlF₃ according to Examples 1 to 3 had remarkably improved discharge capacity and cycle life characteristics compared with the one without coating according to Comparative Example 1.

In addition, the cells including Li[Ni_{0.5}Mn_{0.5}]O₂ coated with AlF₃ according to Examples 4 and 5 had remarkably improved discharge capacity and cycle life characteristics compared with the one without coating according to Comparative Example 2.

TABLE 2

| | | 0.2 C IR drop | 0.5 C IR drop |
|---|---|---|---|
| Li[Ni_{0.5}Mn_{0.5}]O₂ | Example 4 | 0.0320 V | 0.0541 V |
| | Example 5 | 0.0345 V | 0.0698 V |
| | Example 6 | 0.0540 V | 0.089 V |

Referring to Table 2, the cell of Comparative Example 1 had a high IR drop value at 0.2 C and 0.5 C charge and discharge, that is, high resistance, but the ones of Examples 4 and 5 had remarkably deteriorated IR drop values. Since AlF₃ was uniformly coated on the surface of a positive active material, the positive active material deteriorated resistances on the surface, resultantly improving rate and cycle life characteristics.

### Experimental Example 2

The cells of Example 1 and Comparative Example 1 were measured regarding thermal stability by charging and discharging them twice with a 0.2 C-rate up to 3.0 to 4.3V, then charging up to 4.3 V with a constant current and constant voltage (charge up to 1/20 current of a constant current) mode and acquiring a positive electrode under an argon atmosphere.

5 mg of the positive electrode was placed and sealed in a differential scanning calorimetry (DSC) device, and its differential calorie change was measured at 2° C./min. Table 3 shows the temperature and exothermic heat results when it had a highest exothermic peak.

TABLE 3

| | Exothermic | Exothermic |
|---|---|---|
| | temperature (° C.) | heat (J/g) |
| Example 1 | 315.3 | 1949 |
| Comparative Example 1 | 305.6 | 2282 |

Referring to Table 3, the cell including Li[Ni_{1/3}CO_{1/3}Mn_{1/3}]O₂ coated with AlF₃ according to Example 1 had about 9.7° C. increased exothermic temperature and 85% decreased exothermic heat, and thereby had remarkably increased thermal stability compared with the one of Comparative Example 1.

### Experimental Example 3

The cells according to Example 2 and Comparative Example 1 were evaluated regarding high rate characteristic by charging them up to 4.5V at a 0.2 C-rate and discharging them at a 0.2 C-rate to 3.0V, then charging them at a 0.2 C-rate up to 4.5V, discharging at a 0.5 C-rate to 3.0V, charging at a 0.2 C-rate up to 4.5V, discharging at a 1.0 C-rate to 3.0V, charging at a 0.2 C-rate up to 4.3V, and discharging at a 2.0 C-rate to 3.0V, and then calculating them as a discharge capacity percentage at each C-rate based on discharge capacity during the 0.2 C-rate discharge. Table 4 shows the results.

TABLE 4

| | 0.2 C. | 0.5 C. | 1.0 C. | 2.0 C. | 5.0 C. | 10.0 C. |
|---|---|---|---|---|---|---|
| Ex. 1 | 100% | 97.6% | 95.3% | 91.6% | 63.6% | 17.3% |
| | 182 mAh/g | 178.8 mAh/g | 174.5 mAh/g | 168.2 mAh/g | 116.6 mAh/g | 31.7 mAh/g |
| Comp. | 100% | 96.7% | 93% | 89.5% | 56.4% | 12.2% |
| Ex. 1 | 181 mAh/g | 175 mAh/g | 169 mAh/g | 162 mAh/g | 102 mAh/g | 22 mAh/g |

Referring to Table 4, the cell including Li[Ni_{1/3}CO_{1/3}Mn_{1/3}]O₂ coated with AlF₃ had a better rate characteristic than the one of Comparative Example 1. They had a larger difference at a high rate.

### Experimental Example 4

The cells of Examples 6 and 7 and Comparative Examples 3 and 4 were evaluated regarding discharge capacity and cycle life characteristics. The results are provided in the following Table 5. In addition, the results of Examples 2 and 5 are provided in the following Table 5 for reference.

TABLE 5

| | | Discharge | Discharge | |
|---|---|---|---|---|
| | | capacity | capacity | |
| | | (mAh/g) | (mAh/g) | Cycle |
| | | (0.2 C) | (0.5 C) | life (%) |
| Li[Ni_{1/3}Co_{1/3}Mn_{1/3}]O₂ | Ex. 2 | 184.36 | 178.48 | 94.5 |
| | Comp. | 181.11 | 175.31 | 89.3 |
| | Ex. 3 | | | |
| | Ex. 6 | 184.39 | 178.45 | 94.6 |
| Li[Ni_{0.5}Mn_{0.5}]O₂ | Ex. 5 | 175.94 | 165.05 | 94.7 |
| | Comp. | 171.45 | 160.7 | 91.6 |
| | Ex. 4 | | | |
| | Ex. 7 | 175.59 | 165.1 | 94.6 |

As shown in Table 5, when a positive active material coated with AlF₃ is exposed to air for a long time, it may have a negative reaction on the surface, thereby having deteriorated characteristics (Comparative Examples 3 and 4). However, when it is heat-treated again (Examples 6 and 7), it may have discharge capacity and cycle life characteristics similar to an initial positive active material.

### Experimental Example 5

The cells of Examples 8 and 9 were evaluated regarding discharge capacity and cycle life characteristics. The results are provided in the following Table 6. In addition, the following Table 6 shows the results of Examples 2 and 5.

TABLE 6

| | | Discharge | Discharge | |
|---|---|---|---|---|
| | | capacity | capacity | |
| | | (mAh/g) | (mAh/g) | Cycle |
| | | (0.2 C) | (0.5 C) | life (%) |
| Li[Ni_{1/3}Co_{1/3}Mn_{1/3}]O₂ | Ex. 8 | 185.2 | 178.01 | 93.3 |
| | Ex. 2 | 184.16 | 178.48 | 94.5 |
| Li[Ni_{0.5}Mn_{0.5}]O₂ | Ex. 9 | 174.32 | 164.44 | 93.0 |
| | Ex. 5 | 175.94 | 165.05 | 94.7 |

As shown in Table 6, a positive active material coated with (NH₄)₃AlF₆ on the surface (Examples 8 and 9) has discharge capacity and cycle life characteristics that are similar to those of a positive active material coated with AlF₃ on the surface (Examples 2 and 5). Therefore, a positive active material coated with (NH₄)₃AlF₆ on the surface turned out to have better discharge capacity and cycle life characteristics than a positive active material coated with nothing.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of preparing a positive active material for a rechargeable lithium battery, which has a coating compound layer on the surface, comprising:
preparing a complex salt solution by mixing a solution comprising a metal source material and a chelating agent;
disposing the complex salt on the surface of a lithium-included compound by adding a lithium-included compound to the complex salt solution;
adding a fluorine-containing solution to a solution comprising the lithium-included compound having a complex salt on the surface; and
heat-treating the mixture.

2. The method of claim 1, wherein the complex salt solution is prepared in a pH range of 5 to 13.

3. The method of claim 2, wherein the complex salt solution is prepared in a pH range of 7 to 12.

4. The method of claim 1, wherein the metal source material comprises a metal selected from the group consisting of a Group 1 element, a Group 2 element, a Group 3 transition element, a Group 4 transition element, a Group 5 transition element, a Group 6 transition element, a Group 7 transition element, a Group 8 transition element, a Group 9 transition element, a Group 10 transition element, a Group 11 transition element, a Group 12 transition element, a Group 13 element, a Group 14 element, a Group 15 element, a Group 16 element, a Group 18 element, a lanthanide element, and a combination thereof.

5. The method of claim 1, wherein the chelating agent comprises one selected from the group consisting of an ammonium cation-included compound, an organic acid, a polyelectrolyte, and a combination thereof.

6. The method of claim 5, wherein the chelating agent is selected from the group consisting of an ammonium cation-included compound selected from the group consisting of NH₄OH, (NH₄)₂SO₄, NH₄NO₃, and a combination thereof, an organic acid selected from the group consisting of citric acid, glycol acid, and a combination thereof, a polyelectrolyte selected from the group consisting of poly sodium styrene sulfonate, poly peptide, poly acrylic acid, and a combination thereof.

7. The method of claim 5, wherein the chelating agent is an ammonium cation-included compound selected from the group consisting of NH₄OH, (NH₄)₂SO₄, NH₄NO₃, and a combination thereof.

8. The method of claim 1, wherein the metal source material and the chelating agent are mixed in a mole ratio ranging from 1:1 to 1:10.

9. The method of claim 1, wherein the metal source material comprises a metal in an amount of 0.001 to 20 mol % based on the amount of the lithium-included compound.

10. The method of claim 9, wherein the metal source material comprises a metal in an amount of 0.005 to 15 mol % based on the amount of the lithium-included compound.

11. The method of claim 1, wherein the lithium-included compound is capable of intercalating and deintercalating lithium ions, and is selected from the group consisting of a lithium composite metal oxide having a hexagonal crystalline layered structure, a lithium composite metal oxide having a monoclinic or orthorhombic crystalline layered structure, a lithium composite metal oxide having a cubic crystalline spinel structure, a lithium composite metal oxide having an olivine structure, and a combination thereof.

12. The method of claim 11, wherein the lithium-included compound that is capable of intercalating and deintercalating lithium ions is a lithium composite metal oxide represented by the following Chemical Formulae 1 to 7:
LiₐNiₓCo_{y}Mn_{z}M_{1-x-y-z}O₂Q_{σ} [Chemical Formula 1]
wherein in the above Formula 1, M is an element selected from the group consisting of B, Mg, Al, Cr, V, Ti, Fe, Zr, Zn, Si, Y, Nb, Ga, Sn, Mo, W, and a combination thereof, Q is a halogen or sulfur, 1.0≦a≦1.2, 0.0≦x≦0.95, 0.0≦y≦0.7, 0.0≦z≦0.7, 0.0≦1-x-y-z≦0.3, and 0.0≦σ≦0.1;
LiₐCo_{1-x-y}ZrₓM_{y}O₂Q_{σ} [Chemical Formula 2]
wherein in the above Formula 2, M is an element selected from the group consisting of Mg, B, Al, Cr, V, Ti, Fe, Zr, Zn, Si, Y, Nb, Ga, Sn, Mo, W, and a combination thereof, Q is halogen or sulfur, 1.0≦a≦1.2, 0.0≦x≦0.05, 0.0≦y≦0.1, 0.0≦x+y≦0.1, and 0.0≦σ≦0.1;
LiₐMn₁₋ₓMₓO₂Q_{σ} [Chemical Formula 3]
wherein in the above Formula 3, M is an element selected from the group consisting of B, Mg, Al, Cr, V, Ti, Fe, Zr, Zn, Si, Y, Nb, Ga, Sn, Mo, W, and a combination thereof, Q is a halogen or sulfur, 1.0≦a≦1.2, 0.0≦x≦0.5, and 0.0≦σ≦0.1;
LiₐMn₂₋ₓMₓO₄Q_{σ} [Chemical Formula 4]
wherein in the above Formula 4, M is an element selected from the group consisting of B, Li, Mg, Al, Ca, Sr, Cr, V, Ti, Fe, Co, Ni, Zr, Zn, Si, Y, Nb, Ga, Sn, Mo, W, and a combination thereof, Q is a halogen or sulfur, 1.0≦a≦1.3, 0.0≦x≦0.2, and 0.0≦σ≦0.1;
LiₐMn₂₋ₓMₓO₄Q_{σ} [Chemical Formula 5]
wherein in the above Formula 5, M is an element selected from the group consisting of B, Li, Mg, Al, Ca, Sr, Cr, V, Ti, Fe, Co, Ni, Zr, Zn, Si, Y, Nb, Ga, Sn, Mo, W, and a combination thereof, Q is a halogen or sulfur, 1.0≦a≦1.3, 0.3≦x≦0.7, and 0.0≦σ≦0.1;
Li₄₊ₐTi₄₋ₓMₓO₁₂Q_{σ} [Chemical Formula 6]
wherein in the above Formula 6, M is an element selected from the group consisting of Li, Mg, Al, Ca, Sr, Cr, V, Ti, Fe, Co, Ni, Zr, Zn, Si, Y, Nb, Ga, Sn, Mo, W, and a combination thereof, Q is a halogen or sulfur, 0.0≦a≦0.1, 0.0≦x≦0.1, and 0.0≦σ≦0.1; and
LiMₓPO₄Q_{σ} [Chemical Formula 7]
wherein in the above Formula 7, M is an element selected from the group consisting of Co, Ni, Mn, Fe, Mg, V, Ti, Fe, Zr, Zn, Si, Y, Nb, Ga, Sn, Mo, W, and a combination thereof, Q is a halogen or sulfur, 0.0≦a≦0.1, 0.0≦x≦0.1, and 0.0≦σ≦0.02.

13. The method of claim 1, wherein the fluorine source material is selected from the group consisting of NH₄F, HF, and a combination thereof.

14. The method of claim 1, wherein the fluorine source material is used in an amount of 1 to 10 moles based on 1 mole of the metal source material.

15. The method of claim 1, wherein the heat treatment is performed at 300 to 1000° C.

16. The method of claim 14, wherein the method further comprises storing the positive active material for 24 hours or more and heat treating it.

17. The method of claim 16, wherein the heat treatment is performed at 300 to 1000° C.

18. The method of claim 1, wherein the coating compound is selected from the group consisting of a metal fluoride, a metal oxyfluoride, a metal oxide, an ammonium metal fluoride, and a combination thereof.

19. The method of claim 18, wherein the metal fluoride is selected from the group consisting of LiF, NaF, KF, MgF₂, CaF₂, CuF₂, CdF2, FeF2, MnF₂, MgF₂, NiF₂, PbF₂, SnF₂, SrF₂, XeF₂, ZnF₂, AlF₃, BF₃, BiF₃, CeF₃, CrF₃, FeF₃, InF₃, LaF₃, MnF₃, NdF₃, VOF₃, YF₃, CeF₄, GeF₄, HfF₄, SiF₄, SnF₄, TiF₄, VF₄, ZrF₄, VF₅, NbF₅, SbF₅, TaF₅, BiF₅, MoF₆, ReF₆, SF₆, WF₆, and a combination thereof.

20. The method of claim 18, wherein the metal oxyfluoride comprises one selected from the group consisting of a Group 3 transition element, a Group 4 transition element, a Group 5 transition element, a Group 6 transition element, a Group 7 transition element, a Group 8 transition element, a Group 9 transition element, a Group 13 element, a Group 14 element, a Group 15 element, a lanthanide element, and a combination thereof.

21. The method of claim 18, wherein the metal oxide comprises one metal selected from the group consisting of Mg, Ca, Sr, B, Al, Y, Zr, Mo, W, Cr, Fe, Co, Ni, Zn, Ga, Ge, In, Sn, Bi, P, and a combination thereof.

22. The method of claim 18, wherein the ammonium metal fluoride comprises (NH₄)ₓMF_{y} where M is selected from the group consisting of a Group 3 transition element, a Group 4 transition element, a Group 5 transition element, a Group 6 transition element, a Group 7 transition element, a Group 8 transition element, a Group 9 transition element, a Group 13 element, a Group 14 element, a Group 15 element, a lanthanide element, and a combination thereof, x ranges from 1 to 10, and y ranges from 2 to 16.

23. A positive active material for a rechargeable lithium battery prepared according to claim 1.

24. A rechargeable lithium battery comprising:
a positive electrode comprising the positive active material of claim 1;
a negative electrode comprising a negative active material; and
an electrolyte.
